(19) United States
(12) Patent Application Publication
(10) Pub. No.: US 2008/0256441 A1
(43) Pub. Date: Oct. 16, 2008

(54) Flash rich textfields

(75) Inventor: Jonathan New, San Mateo, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/787,618

(22) Filed: Apr. 16, 2007

(51) Int. Cl. G06F 3/048; G06F 15/00; G06F 17/00

(52) U.S. Cl. 715/256; 715/765; 715/243; 715/221

(57) ABSTRACT

Techniques are described for providing full support of inline images within online instant messaging applications such as those developed for Flash. When a message contains both a text component and an image component, the image component is separated from the text component. The location of the text is measured dynamically either using an XML ruler component or a bitmap ruler component. Based upon the locations of the text, the images are placed on an invisible image layer. The text is placed on a textfield to be displayed to the user. The image or textfield layer is then placed on top of the other of the image or textfield layer so that both the text component and the image component of the message are visible to the user.

### FIELD OF THE INVENTION

The present invention relates to providing full in-line image support for dynamic textfields in a multimedia web environment.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Online instant messaging refers to real-time communications made between two or more users over a computer network, primarily the Internet. Online instant messaging is performed using instant messaging applications, which may be implemented as a standalone application or in conjunction with a web browser.

Online instant messaging is comprised of one or more messages between users. A message comprises a user request that may contain a text component and an image component. An example of an online conversation:

> Hello, how are you?

>> I am fine

Each statement in the above conversation is a message. “Hello, how are you?” is the first message from a first user. “I am fine” is the second message and the reply from a second user.

As online instant messaging has progressed, additional forms of expression beyond the literal word have developed. One example is the use of an emoticon. An emoticon is a sequence of ordinary printable characters, such as “:-)”, “:(”, or “=P”, intended to represent a human facial expression and convey an emotion. For example, the first example is a smiley face connoting happiness, the second is a sad face expressing sadness, and the last indicates humor. Emoticons may be used to compensate for emotion or additional meaning where purely written communication lacks complimentary signals such as facial expression, body language, and vocal intonation.

In online instant messaging applications, text emoticons are often automatically replaced with small corresponding images. These image emoticons may be fairly simple and replace the most common character sequences, but can also be complex with more specialized meaning. Complex emoticons images may be displayed by a moving animation with audible phrases. Because complex emoticon images do not correspond to simple text character sequences, complex emoticons are input with the help of a menu or popup windows. As used herein, “emoticons” refer to small corresponding images of the text emoticon and complex emoticon images.

A stand alone online instant messaging application does not require the use of any additional host program to be running in conjunction with the application. Examples of stand-alone applications include Yahoo! Instant Messenger, Windows Live Messenger, and AOL Instant Messenger.

Online instant messaging may also be performed using plug-ins in conjunction with a web browser. A plug-in is a computer program that interacts with a main or host application, to provide a specific function upon request. For example, plug-ins enable the host application to read or edit specific types of files like multimedia files or to display specific content within the host application. To enable the host application to use the plug-in, the plug-in must be registered with the host application and then the host application provides a protocol by which data is exchanged with the plug-in.

A plug-in used with most instances of web browsers is Adobe Flash®. Flash provides a powerful platform for rich internet applications and motion graphics. Flash is composed of two separate components, the Flash Player and the multimedia authoring program used to create content. The Flash Player provides support for vector and raster graphics, a scripting language called ActionScript and bi-directional streaming of audio and video. Flash files are identified with a .swf file extension. Flash has an extensive penetration rate with web users and is very ubiquitous.

Flash technology has become a popular method for adding animation and interactivity to web pages such as in online greeting cards or updating sports scores. Flash is commonly used to create animations, to integrate video into web pages, and to develop multimedia-rich internet applications. As a result, Flash is also used to implement online instant messaging within web browsers.

Messages are created by the user and displayed in a display area of the online instant messaging application. As mentioned previously, messages comprise an image component and a text component. The image component refers to one or more images that may be part of a user message once it is displayed. Images comprise emoticon images, gif images, jpeg images, video or any other file containing visual content. For example, if a user submits the message “Hello :)”, then the online instant messenger will display the emoticon “:)” as an image of a smiley face. The message in the display will appear as “Hello [image of smiley face].” The image of the smiley face is the image component of the message. The text component comprises any text that may be part of the user request. Text comprises letters, words, and symbols to produce a communication. Text also possesses many format properties such as, but not limited to, font, font size, and color.

Flash places messages into a textfield, which is an object that contains and displays the text component and image component. Unfortunately, when Flash is used in online instant messaging, emoticons implemented as an image may appear in a message incorrectly because Flash does not have full inline image support with the accompanying text. An inline image, as used herein, is an image that is embedded within a message and displayed accompanying the text component.

FIG. 1 shows the display area of a messaging application in three different scenarios after a messaging request has been submitted. In area 101, the display area is shown for a message in which an emoticon, represented here by a circle, is located in the beginning of the message. The inline image and the text component display correctly. 103 shows the display area of a message where an emoticon is placed at the end of the message. 105 shows the display area of a message where an emoticon is placed in the middle of the message. However, as seen in 103 and 105 of FIG. 1, when an emoticon is supposed to be placed at the end of a message or in the middle of a message, the emoticon is instead displayed on the line following the text component and not on the line where the message is located. As a result, there is a clear need for techniques that provide full support for inline images within instant messaging applications such as those used with Flash. Furthermore, this full support for inline images should be capable of handling texts of different fonts or sizes and capable of handling situations in which the existing texts are resized.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of text and inline images displayed correctly and incorrectly in various instances;

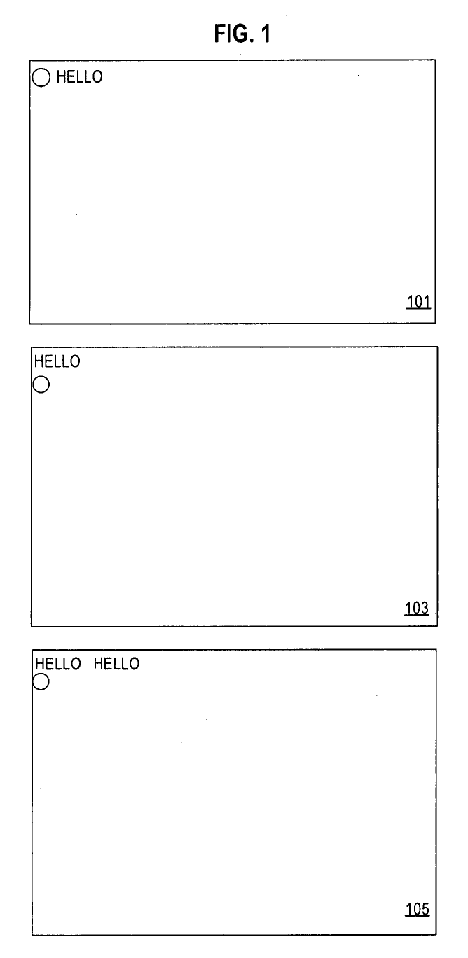

FIG. 2 is a flow diagram of an embodiment of the technique to determine measurements based on the text component for an XML ruler component;

FIG. 3 is a flow diagram of an embodiment of the technique to determine measurements based on the text component for an bitmap ruler component; and

FIG. 4 is a block diagram of a computer system on which embodiments of the invention may be implemented.

### DETAILED DESCRIPTION

Techniques are described for providing full support of inline images within online instant messaging applications such as those used in Flash. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

In one embodiment of the invention, once a user enters a message to an online instant messaging application, a module determines whether the message contains an image component or text that will be translated into an emoticon or other image. The module, herein called RichTextfield, is described in the context of a Flash plug-in, but variations of this module may be implemented in other multimedia formats that support instant messaging and images.

The RichTextfield module examines the message for an image tag that indicates that an image is to be displayed with the message. For example, within the context of web browsers, if the message contains an “img” tag, then the message is to display an image. If no image component to the message is found, then the message contains only a text component, and the RichTextfield module sends the message to other components of the instant messaging application to handle the message directly. Flash correctly handles messages that contain only text components. Flash places the message into a textfield, which is an object that contains and displays the text component and image component.

If the message is to display an image, the RichTextfield module separates the text component and the image component of the message. First, the RichTextfield module determines whether the message contains an image. If there is no image in the message, then the RichTextfield module sends the message directly to a Flash textfield component as Flash correctly handles messages where there is no image component in the message. Alternatively, if there is a text component in front of an image component, then the RichTextfield module extracts data about the message, herein referred to as message metadata. The message metadata includes the total number of images in the message, the portion of text located only before the image, and the total text of the message. Next, the text component is sent to the Flash textfield for display and the text of the text component is measured to determine the location of the displayed text.

### Measuring the Text Component

The RichTextfield module places the text of the text component into a form-fitting dynamic textfield, specified herein as the ruler component, that is not visible to the user. The ruler component has two primary functions: to determine which text will be displayed on the last line before the image, and to calculate the appropriate X and Y coordinates for the image component by measuring this portion of the text. For example, if the user request is the message “Hello World,” then the ruler component surrounds the message “Hello World” and the width properties and the height properties of the ruler component can be used to determine the width and height of the message.

In an embodiment, when text is placed in the ruler component, the ruler component form-fits around the text. The RichTextfield module can then determine the width of the ruler component and use the width property as the width of the text. The width property provides the X coordinate for the images.

The vertical position of the text is determined using the ruler component by finding the height of the ruler component. In another embodiment, when text of different heights are next to each other, such as with different sized fonts, the height of the entire line of the text is determined, and not just the text that is closest to the image. The vertical property of the text component provides the Y coordinate for the images.

### Two Different Ruler Components

In an embodiment, there are two different ruler components: one based on XML, and the other based on bitmap. The XML ruler component is used with Flash version 7. The bitmap-based ruler is used with Flash version 8. Additional ruler components may be created should any additional technologies become available to improve the efficiency of the ruler component.

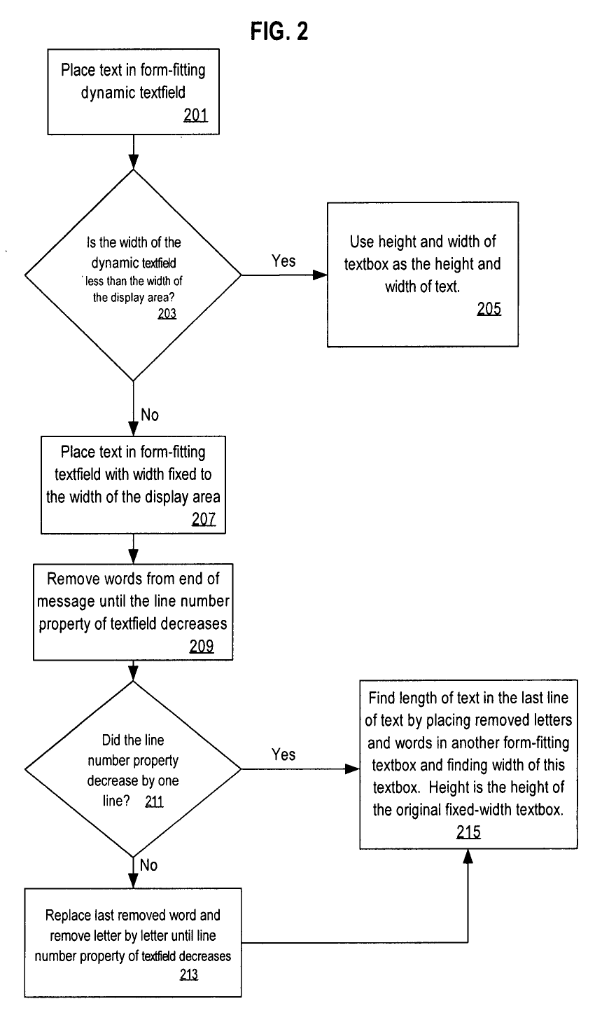

The XML ruler component uses the message data to determine the location of the image. One difficulty with using only the form-fitting dynamic textfield to measure the height and width of the text component is that these measurements can be incorrect when the message wraps to a second or third line. An example of a process for using the XML ruler component in order to measure the locations of the text is illustrated in FIG. 2. In block 201, the text is placed in a form-fitting dynamic textfield. To determine whether the message wraps to another line, the width of the form-fitting XML ruler component is compared to the width of the display area in block 203. If the width property of the XML ruler component is shorter than the width of the display area, then, in block 205 the text component is on a single line and no further processing is required.

In the present example, when the width property of the form-fitting XML ruler component is longer than the display area, additional steps are performed. The goal is to determine the length of the text component only in the last line of the message. In an embodiment, as shown in block 207, the XML ruler component is altered to remain a fixed width to match the width of the display area. The message in the XML ruler component no longer fits on a single line and the message wraps to the next line.

In one embodiment of the invention, to determine the words or letters that comprise the last line of the message, the RichTextfield module removes words from the end of the message one by one in block 209. When a word is removed, the RichTextfield module determines whether the line number property of the XML ruler component has changed. If a change in the line number property occurs, then the last line begins with the last word that was removed. The removed words are placed into another XML ruler component to find the width component of the removed words in block 215. This width component indicates the width component of the last line of text.

In another embodiment, a message can occur with very long words that are longer than the width property of the XML ruler component and removal may be made character by character. For example, a message might be the letter “a” typed 500 times in succession, followed by a smiley emoticon. The width of the display area might be 200 characters long. Under such circumstances, there might be three different lines of the character “a,” the first two lines with 200 characters, and the last line with 100 characters. If entire words were removed word by word, then all the characters would be removed and the RichTextfield module would be unable to determine where the last line ended. Thus, in one embodiment of the invention, the RichTextfield module determines whether the line number property of the XML ruler component decreased by more than one line in block 211. If the line number property decreased by a single line, then length and height is determined using the word-by-word removal technique discussed above with reference to block 209.

In an embodiment, if a word is removed and the RichTextfield module determines that the line number property has been decreased by more than one from the XML ruler component, then the word is replaced and instead, individual letters are removed one by one until a line number property is decreased by one in block 213. The RichTextfield module determines the length of the last line of text by measuring the removed words and letters in block 215.

For example, two messages submitted by users might be:

M1> What would you like to do today?=)

M2> Go to the beach. :)

Message M1, when placed in a form-fitting ruler component like in block 201, would make the ruler component 32 characters long. Character lengths are used when discussing widths in this example, however, a variety of increments of length may be used, such as pixels. The display width might have a width 20 characters long. Under such circumstances, the width of the form-fitting ruler component is not less than the width of the display area in block 203. Thus, the text of message M1 would be placed in a form-fitting textfield with a width fixed to the width of the display area in block 207. A representation of the message M1 in the fixed-width textfield is:
What would you like to do today?

Then the words from the end of the message would be removed one by one until the line number property of the textfield decreases as in block 209. “today?” would be removed without any decrease. “do” would also be removed without any decrease. When “to” is removed, the line number property of the textfield decreases. The line number property would have decreased by a single line in block 211. The width of the text in the last line would be found by placing the removed words “to do today?” in another form-fitting textbox and finding the width of the textbox in block 215.

Message M2, when placed in a form-fitting ruler component like in block 201, would make the ruler component 16 characters long. The display width would still be 20 characters long. Under such circumstances, the width of the form-fitting ruler component is less than the width of the display area in block 203. The height and width of the textbox would be used as the height and width of the text in block 205.

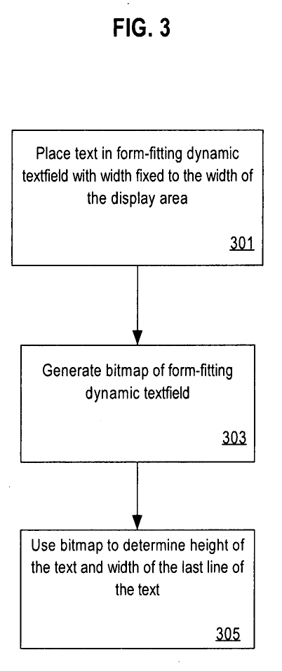

In an embodiment, if Flash version 8 is detected, then the bitmap ruler component is employed. Otherwise, the XML ruler component is used. An example of a process for using the XML ruler component in order to measure the locations of the text is illustrated in FIG. 3. The bitmap ruler component first places the text component into a form-fitted textfield that is the same width of the display area in block 301. Then a bitmap of the form-fitted textfield, with dark pixels indicating text that is present and other pixels remaining white, is generated in block 302. Using the bitmap, the X and Y coordinates are determined by finding the dark pixel that is the furthest to the right and bottom of the bitmap in block 303. Removing words or letters is not required when the bitmap ruler component is employed.

### Image Layer

In one embodiment of the invention, the separated image or images of the image component are placed on an image layer at locations that are based on the X and Y coordinates determined by the ruler component. The image layer is a layer that contains the images of the image component and is transparent to the user. The image layer is placed on top of the Flash textfield so that both the image component and the text component are displayed to the user. In another embodiment, the image layer is placed below a transparent version of the Flash textfield so that both the text component and the image component are displayed to the user.

In an embodiment, the image layer (with images placed therein) is stored in a container that is implemented as the pre-built Flash MovieClip class. The MovieClip class can be used to store many different kinds of multimedia files, such as other images or videos, or even another MovieClip.

In another embodiment, when the image is placed in the middle of text, the RichTextfield module leaves, in the text, the proper amount of space for the image. For example, an image is placed between the text “Hello [image] Hello”. In such an embodiment of the invention, when the text is placed on the text layer, the text is adjusted to leave a sufficient amount of space for the image to be placed.

In one embodiment of the invention, the RichTextfield module determines where to place each image of the image component. A display area may contain multiple messages, and so in one embodiment of the invention, the RichTextfield module determines from which point in the display area to place the image. In an embodiment, the location of each message is determined by placing a small invisible image to act as a numbered anchor at the beginning of each message. The numbered anchor is accurate because images placed at the beginning of a message are displayed correctly in Flash. These numbered anchors are used by the RichTextfield module to indicate the origin point for an image's X and Y coordinates in each message and are invisible and thus not noticeable by a user.

### Changes to Formatting or the Display Area

In one embodiment of the invention, an event handler in the RichTextfield module detects changes to the display area and any other formatting changes. In one scenario, the display area may be resized, thereby upsetting the formatting and line wrapping in the text. In an embodiment, an event handler in the RichTextfield module detects the user request to resize the display area. The text component for each message is re-measured to reposition each of the images in the image component. For example, a user might reduce the display area and introduce line wrapping in messages that previously did not contain line wrapping. Under such circumstances, the event handler detects the change in display area and re-measures the text component to make any necessary adjustments to the positions of the images.

In another embodiment, an event handler detects format changes to the text component, such as changes in fonts or font size. Additional changes may be made. For example, text color may be changed or the text may be highlighted. This may cause the location of text to change. In response, the RichTextfield module re-measures the text component and repositions each of the images accordingly.

In an embodiment of the invention, the image may be altered to better fit the size of text. In cases where the image is extremely large, the image may be re-sized in order to allow the image to fit within the text component of the message in the display area. In another embodiment, line spacing of the text may be adjusted to account for larger sizes of images.

### Hardware Overview

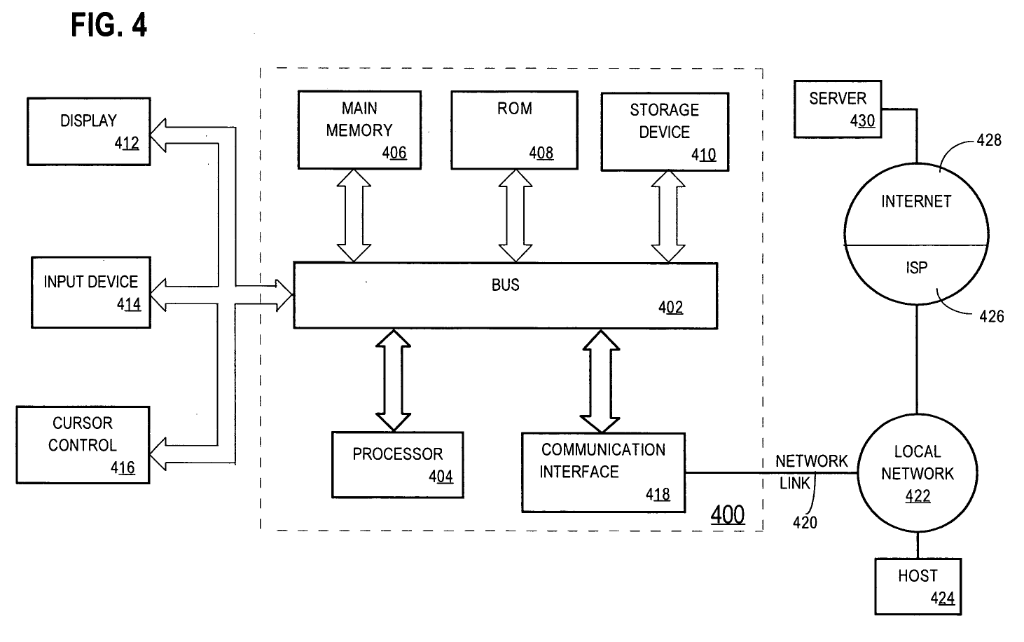

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
receiving, from a user, a request that specifies an image component and a text component;
determining a first location in a display area at which the text component will be displayed;
identifying display locations of text within the text component, wherein identifying the display locations of text within the text component further comprises (a) placing the text within the text component in a form-fitting textfield layer, and (b) determining the locations of the text within the text component based on dimensions of the form-fitting textfield layer,
placing text of the text component on a textfield layer at the first location;
determining, based on the first location, a second location at which to display one or more images of the image component relative to the text component;
placing images of the image component on an image layer at the second location;
displaying at least one of the image layer and the textfield layer on top of the other of the image layer and the textfield layer in a display area.

2. The method of claim 1, wherein determining the locations of the text within the text component based on dimensions of the form-fitting textfield layer further comprises the steps:
determine whether a width dimension on the form-fitting textfield layer is larger than a width dimension of the display area;
upon determining that the width dimension on the form-fitting textfield layer is larger than a width dimension of the display area, place the text component in a second form-fitting textfield with a width fixed to the width of the display area;
remove last words of the text component until a line number property of the second textfield decreases;
determine whether the line number property of the second textfield decreases by one line;
upon determining that line number property of the second textfield decreases by one line, replace last removed word and remove letters of last removed word until line number property of textfield decreases;
determine length of text in the last line of text by placing removed words and letters in a third form-fitting textbox and finding a width property of the third form-fitting textbox.

3. The method of claim 1, wherein the second location is determined relative to an anchor placed at the beginning of a message.

4. The method of claim 1 further comprising the steps of:
receiving a second request from the user, wherein the second request comprises a request that alters the first location;
upon receiving the second request from the user, identifying the display locations of text within the text component, wherein identifying the display locations of text within the text component further comprises the steps:
placing the text within the text component in a form-fitting textfield layer,
determining the locations of the text based on dimensions of the form-fitting textfield layer,
placing text of the text component on the textfield layer at the third location;
determining, based on the third location, a fourth location at which to display one or more images of the image component relative to the text component;
placing images of the image component on an image layer at the fourth location;
displaying at least one of the image layer and the textfield layer on top of the other of the image layer and the textfield layer in a display area.

5. The method of claim 1, wherein the image layer is invisible to the user.

6. A method, comprising:
receiving, from a user, a request that specifies an image component and a text component;
determining a first location in a display area at which the text component will be displayed;
identifying the display locations of text within the text component, wherein identifying the display locations of text within the text component further comprises (a) placing the text in a form-fitting textfield layer, and (b) determining the locations of the text based on the dimensions of the form-fitting textfield layer;
placing text of the text component on a text layer at the first location;
determining, based on the first location, a second location at which to display one or more images of the image component relative to the text component;
placing images of the image component on an image layer at the second location;
displaying at least one of the image layer and the textfield layer on top of the other of the image layer and the textfield layer in a display area.

7. The method of claim 6, wherein the second location is determined relative to an anchor placed at the beginning of a message.

8. The method of claim 6 further comprising the steps of:
receiving a second request from the user, wherein the second request comprises a request that alters the first location;
upon receiving the second request from the user, identifying the display locations of text within the text component, wherein identifying the display locations of text within the text component further comprises the steps:
placing the text within the text component in a form-fitting textfield layer,
determining the locations of the text based on dimensions of the form-fitting textfield layer,
placing text of the text component on the textfield layer at the third location;
determining, based on the third location, a fourth location at which to display one or more images of the image component relative to the text component;
placing images of the image component on an image layer at the fourth location;
displaying at least one of the image layer and the textfield layer on top of the other of the image layer and the textfield layer in a display area.

9. The method of claim 6, wherein the image layer is invisible to the user.

10. A method, comprising:
receiving, from a user, a request that specifies an image component and a text component;
determining a first location in a display area at which the text component will be displayed;
placing text of the text component on a text layer at the first location;
determining, based on the first location, a second location at which to display one or more images of the image component relative to the text component;
placing images of the image component on an image layer at the second location;
displaying at least one of the image layer and the textfield layer on top of the other of the image layer and the textfield layer in a display area.

11. The method of claim 10, wherein the image layer is invisible to the user.

12. The method of claim 10, wherein determining dynamically the first location is performed with an XML ruler component.

13. The method of claim 10, wherein determining dynamically the first location is performed with a bitmap ruler component.

14. The method of claim 10 further comprising the steps of:
receiving a second request from the user, wherein the second request comprises a request that alters the first location;
upon receiving the second request from the user, determining a third location in a display area at which the text component will be displayed;
placing text of the text component on the textfield layer at the third location;
determining, based on the third location, a fourth location at which to display one or more images of the image component relative to the text component;
placing images of the image component on an image layer at the fourth location;
displaying the image layer on top of the textfield layer in a display area.

15. A machine-readable medium carrying one or more sequences of instructions which, when executed by one or more processors, causes the one or more processors to perform the method recited in claim 1.

16. A machine-readable medium carrying one or more sequences of instructions which, when executed by one or more processors, causes the one or more processors to perform the method recited in claim 2.

17. A machine-readable medium carrying one or more sequences of instructions which, when executed by one or more processors, causes the one or more processors to perform the method recited in claim 3.

18. A machine-readable medium carrying one or more sequences of instructions which, when executed by one or more processors, causes the one or more processors to perform the method recited in claim 4.

19. A machine-readable medium carrying one or more sequences of instructions which, when executed by one or more processors, causes the one or more processors to perform the method recited in claim 5.

20. A machine-readable medium carrying one or more sequences of instructions which, when executed by one or more processors, causes the one or more processors to perform the method recited in claim 6.

21. A machine-readable medium carrying one or more sequences of instructions which, when executed by one or more processors, causes the one or more processors to perform the method recited in claim 7.

22. A machine-readable medium carrying one or more sequences of instructions which, when executed by one or more processors, causes the one or more processors to perform the method recited in claim 8.

23. A machine-readable medium carrying one or more sequences of instructions which, when executed by one or more processors, causes the one or more processors to perform the method recited in claim 9.

24. A machine-readable medium carrying one or more sequences of instructions which, when executed by one or more processors, causes the one or more processors to perform the method recited in claim 10.

25. A machine-readable medium carrying one or more sequences of instructions which, when executed by one or more processors, causes the one or more processors to perform the method recited in claim 11.

26. A machine-readable medium carrying one or more sequences of instructions which, when executed by one or more processors, causes the one or more processors to perform the method recited in claim 12.

27. A machine-readable medium carrying one or more sequences of instructions which, when executed by one or more processors, causes the one or more processors to perform the method recited in claim 13.

28. A machine-readable medium carrying one or more sequences of instructions which, when executed by one or more processors, causes the one or more processors to perform the method recited in claim 14.
